(19) United States
(12) Patent Application Publication
(10) Pub. No.: US 2018/0135768 A1
(43) Pub. Date: May 17, 2018

(54) Check valve

(71) Applicant: Chin-Hua Ho, Changhua City (TW)

(72) Inventor: Chin-Hua Ho, Changhua City (TW)

(21) Appl. No.: 15/871,024

(22) Filed: Jan. 14, 2018

(51) Int. Cl. F16K 15/14

(52) U.S. Cl. CPC F16K 15/148

(57) ABSTRACT

A check valve includes a hollow, cylindrical body including inlets through a bottom, a receptacle on a center of the bottom with the inlets therearound, an O-ring mounted on an outer surface of the body, and a seat on a joining portion of the bottom of the body and an inner surface of the body; a flexible disc including a flat on one surface and a peg extending from a center of the other surface, the peg being disposed in the receptacle to secure the disc to the body wherein an edge of the other surface of the disc is rested upon the seat; and a hollow, cylindrical guide secured to the body, the guide including a stem urging against a center of the flat, and outlets through an end to communicate with inside of the body. The inlets are blocked by the disc in a closed position.

### BACKGROUND OF THE INVENTION

### 1. Field of the Invention

The invention relates to check valves and more particularly to a check valve having improved characteristics.

### 2. Description of Related Art

A conventional check valve is shown in FIGS. 1 to 3 and comprises a tubular body A, a cup-shaped closing member D including a stem D1 projecting from a center of a bottom, an O-ring E put on an annular groove (not numbered) of an outer surface of the closing member D, a hollow guide B secured to the body A and including an axial sleeve B1 loosely put on the stem D1, and four channels B2 around the sleeve B1, and a torsion spring C put on the sleeve B1 and having one end anchored on the bottom of the closing member D and the other end urging against internal walls (not numbered) of the guide B.

The torsion spring C expands to push the closing member D and urge the O-ring E against a seat (not numbered) on an inner surface of the body A, thereby blocking fluid flow in a closed position (see FIG. 2).

In response to forward flow W and pressure of the flow W is greater than force exerted on the closing member D by the spring C, the closing member D disengages from the seat. As a result, the flow W passes through an annular gap between the closing member D and the seat and the channels B2 to an outlet (see FIG. 3).

However, a small volume of the flow W may leak by passing through a gap between the stem D1 and the sleeve B1.

Thus, the need for improvement still exists.

### SUMMARY OF THE INVENTION

It is therefore one object of the invention to provide a check valve comprising a cylindrical body being hollow and including a plurality of inlets through a bottom, a receptacle on a center of the bottom with the inlets therearound, an O-ring mounted on an outer surface of the body, and a seat on a joining portion of the bottom of the cylindrical body and an inner surface of the cylindrical body; a flexible disc including a flat on one surface and a peg extending from a center of the other surface, the peg being disposed in the receptacle to secure the disc to the cylindrical body wherein an edge of the other surface of the flexible disc is rested upon the seat; and a cylindrical guide being hollow and secured to the cylindrical body, the cylindrical guide including a stem urging against a center of the flat, and a plurality of outlets through an end to communicate with inside of the cylindrical body; wherein the inlets are blocked by the flexible disc in a closed position.

The above and other objects, features and advantages of the invention will become apparent from the following detailed description taken with the accompanying drawings.

### BRIEF DESCRIPTION OF THE DRAWINGS

FIG. 1 is an exploded view of a conventional check valve;

FIG. 2 is a longitudinal sectional view of the assembled check valve in a closed position;

FIG. 3 is a view similar to FIG. 2 showing the check valve in an open position;

FIG. 4 is an exploded view of a check valve according to a first preferred embodiment of the invention;

FIGS. 5A and 5B are longitudinal sectional view of the body;

FIG. 6 is a longitudinal sectional view of the disc;

FIGS. 7A and 7B are longitudinal sectional view of the guide;

FIGS. 8A and 8B are perspective views of the assembly check valve shown in FIG. 4;

FIG. 9 is a longitudinal sectional view of FIG. 8A showing the check valve in a closed position;

FIG. 10 is a view similar to FIG. 9 showing the check valve in an open position;

FIG. 11 is an exploded view of a check valve according to a second preferred embodiment of the invention;

FIG. 12 is a longitudinal sectional view of the assembled check valve of FIG. 11 showing the check valve in an open position;

FIG. 13 is an exploded perspective view showing the check valve of the invention to be mounted in a handheld showerhead;

FIG. 14 is an exploded perspective view showing the check valve of the invention to be mounted in a wall mounted showerhead; and

FIG. 15 is an exploded perspective view showing the check valve of the invention to be mounted besides faucets.

### DETAILED DESCRIPTION OF THE INVENTION

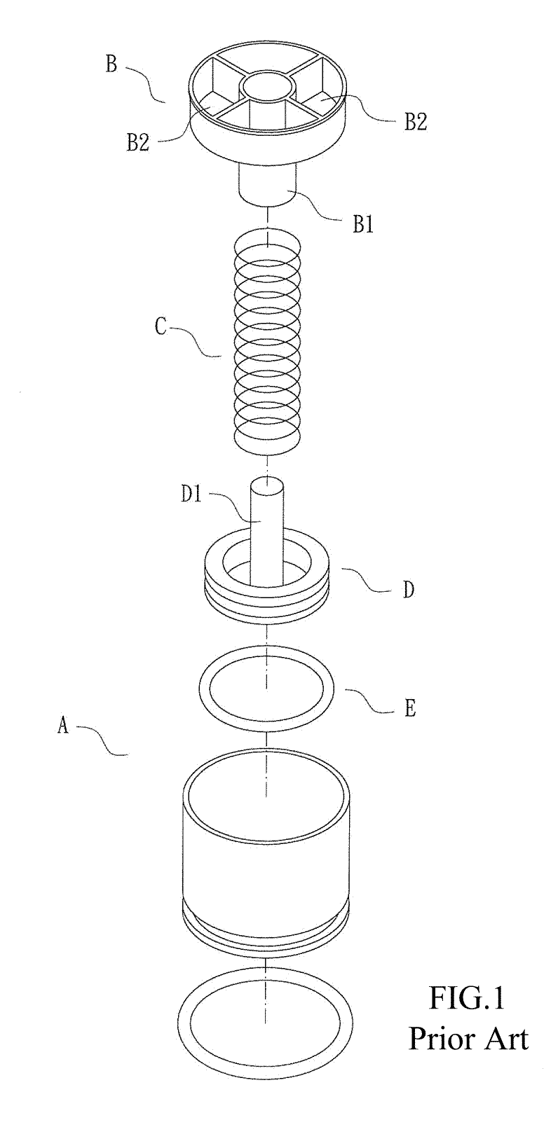

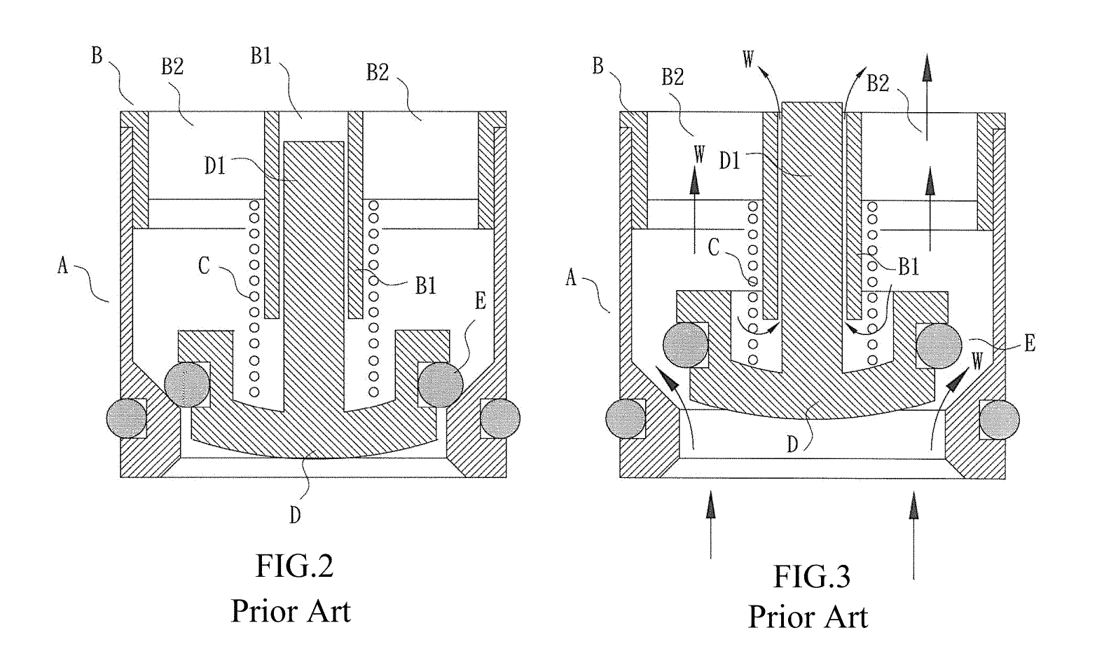

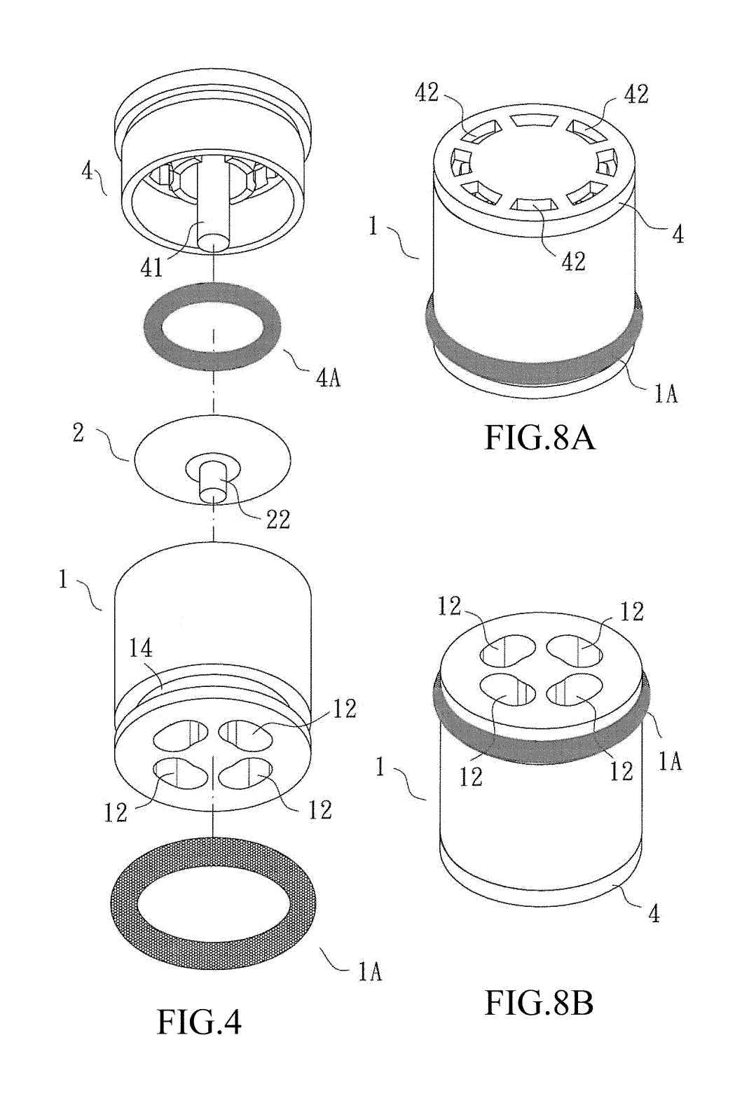

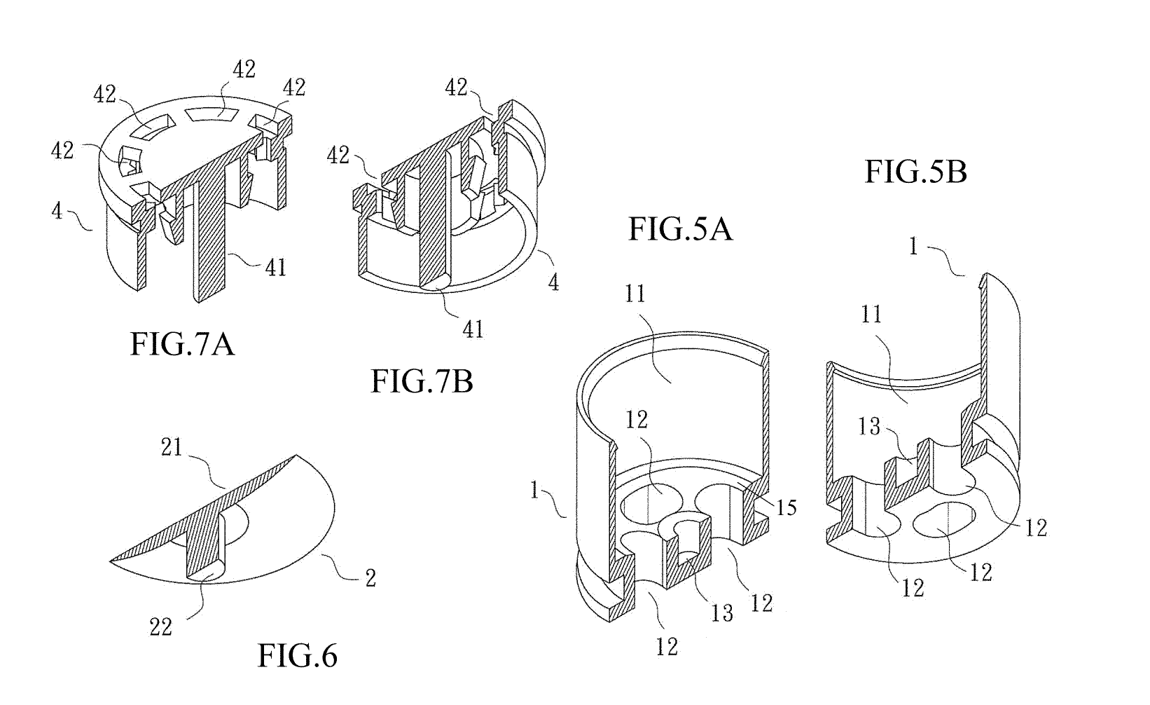

Referring to FIGS. 1 to 10, a check valve in accordance with a first preferred embodiment of the invention comprises the following components as discussed in detail below.

A hollow, cylindrical body 1 includes an internal space 11, four inlets 12 through a bottom, a receptacle 13 on a center of the bottom with the inlets 12 therearound, an annular groove 14 formed on an outer surface of the body 1 adjacent to the inlets 12 with an O-ring 1A disposed therein, and a seat 15 on a joining portion of the bottom of the body 1 and an inner surface of the body adjacent to the inlets 12.

A flexible disc 2 includes a flat 21 on one surface and a peg 22 extending from a center of the other opposite surface and completely disposed in the receptacle 13 to secure the disc 2 and the body 1 together. Further, the edge of the other surface of the disc 2 is rested upon the seat 15.

A hollow, cylindrical guide 4 is secured to the body 1 and includes a stem 41 extending from a center to urge against a center of the flat 21, a plurality of outlets 42 spaced around an edge of one end surface and through one end surface to communicate with the space 11, and an annular, grooved member 43 spaced around the stem 41 with an O-ring 4A disposed therein.

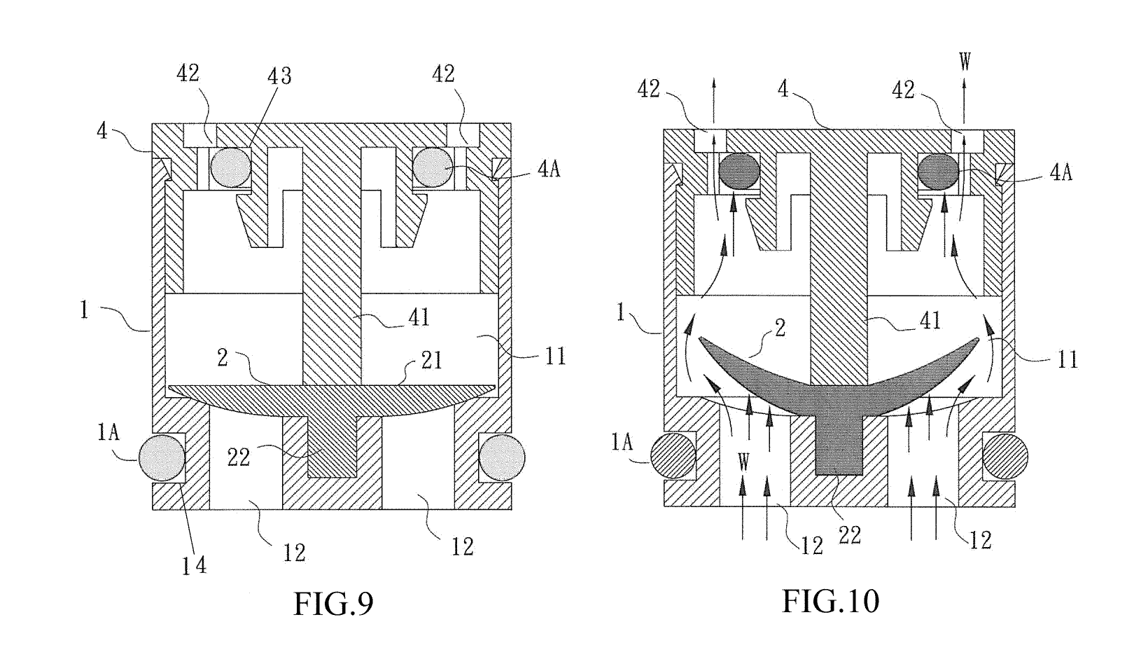

The inlets 12 are blocked by the disc 2 in a closed position (see FIG. 9). In response to forward flow W and pressure of the flow W is greater than force exerted on the seat 15 by the disc 2, the disc 2 bends flexibly, inwardly. As a result, the flow W passes through a gap between the disc 2 and the seat 15, the space 11, and inside of the guide 4 to leave the check vale through the outlets 42 (see FIG. 10).

It is envisaged by the invention that the disc 2 may return to its normal closed position if the flow W is sufficiently slow or stops, thereby blocking the reverse flow.

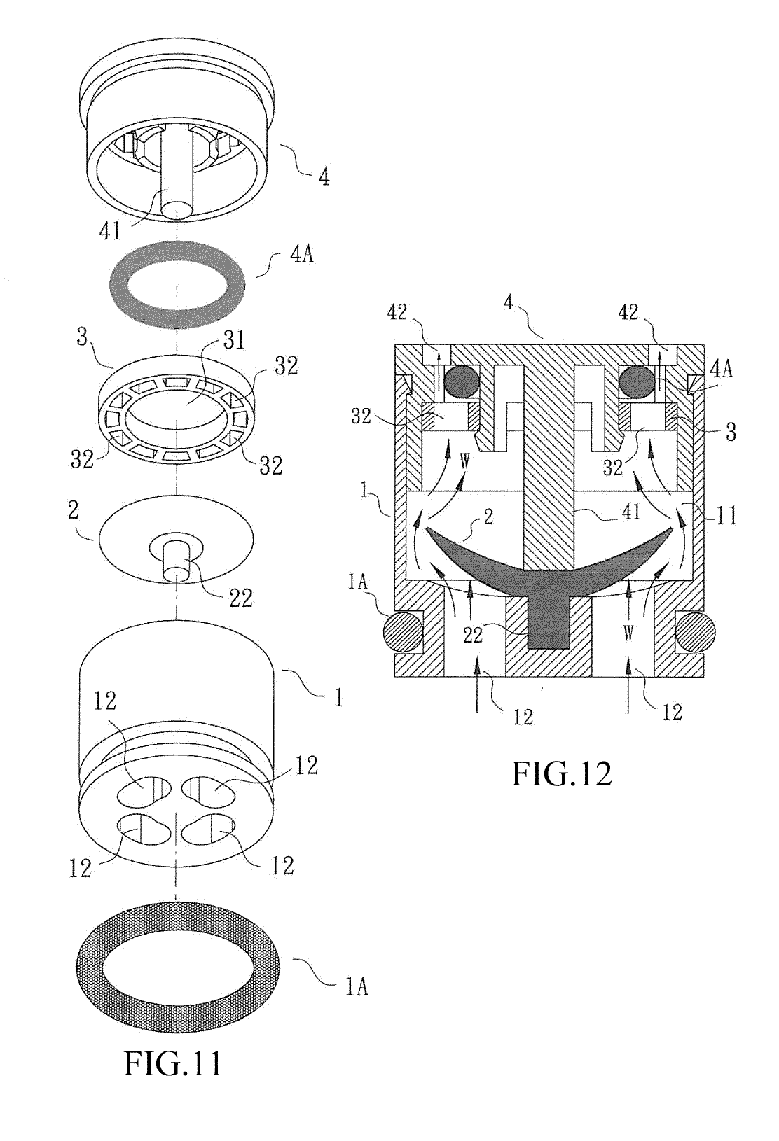

Referring to FIGS. 11 and 12, a check valve in accordance with a second preferred embodiment of the invention is shown. The characteristics of the second preferred embodiment are substantially the same as that of the first preferred embodiment except the following: A ring 3 includes a central channel 31 and a plurality of through holes 32 around the channel 31. The ring 3 is disposed in the grooved member 43 adjacent to the O-ring 4A. The provision of the ring 3 can regulate the flow W.

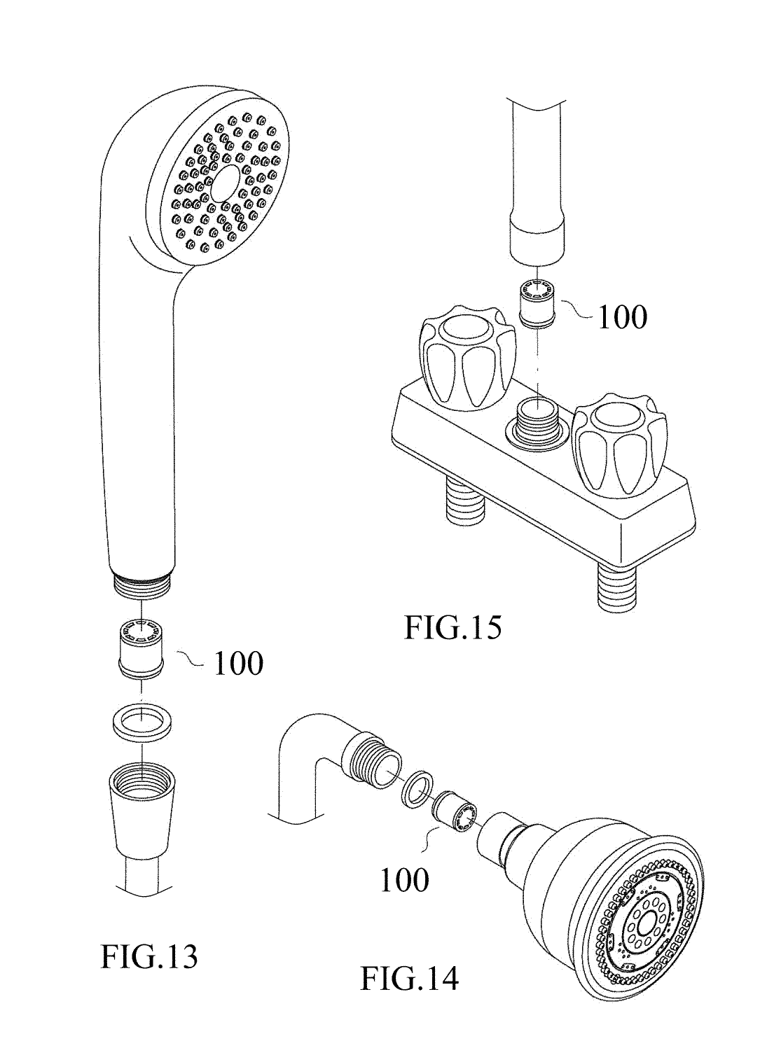

Referring FIG. 13, a check valve 100 of the invention is to be mounted in a handheld showerhead.

Referring to FIG. 14, a check valve 100 of the invention is to be mounted in a wall mounted showerhead.

Referring to FIG. 15, a check valve 100 of the invention is to be mounted besides faucets.

While the invention has been described in terms of preferred embodiments, those skilled in the art will recognize that the invention can be practiced with modifications within the spirit and scope of the appended claims.

What is claimed is:

1. A check valve comprising:
a cylindrical body being hollow and including a plurality of inlets through a bottom, a receptacle on a center of the bottom with the inlets therearound, an O-ring mounted on an outer surface of the body, and a seat formed on a joining portion of the bottom of the cylindrical body and an inner surface of the cylindrical body;
a flexible disc including a flat on one surface and a peg extending from a center of the other surface, the peg being disposed in the receptacle to secure the disc to the cylindrical body wherein an edge of the other surface of the flexible disc is rested upon the seat; and
a cylindrical guide being hollow and secured to the cylindrical body, the cylindrical guide including a stem urging against a center of the flat, and a plurality of outlets through an end to communicate with inside of the cylindrical body;
wherein the inlets are blocked by the flexible disc in a closed position.
